(19) United States
(12) Patent Application Publication
(10) Pub. No.: US 2023/0235742 A1
(43) Pub. Date: Jul. 27, 2023

(54) PORTABLE ELECTRIC FAN

(71) Applicant: HOTECK INC., Taichung City (TW)

(72) Inventors: CHUNG-YU LIN, Taichung City (TW); CHIA-WEI CHANG, Taichung City (TW); KAI-JEN TSAI, Taichung City (TW); MIN-YUAN HSIAO, Taichung City (TW)

(21) Appl. No.: 17/721,336

(22) Filed: Apr. 14, 2022

(30) Foreign Application Priority Data
Jan. 21, 2022 (TW) 111200833

(51) Int. Cl. F04D 25/06; F21V 33/00; F04D 25/08

(52) U.S. Cl. CPC F04D 25/0673; F21V 33/0096; F04D 25/08; F21Y 2115/10

(57) ABSTRACT

A portable electric fan is provided and includes a shell, a fan module, and a plurality of combined seat groups. The shell has a first surface, a second surface opposite to the first surface, and a surrounding side surface that is connected to the first surface and the second surface. The shell has a hollow portion. The fan module is mounted in the hollow portion. The combined seat groups are mounted on the surrounding side surface, and each of the combined seat groups includes two bases and a bracket detachably mounted to the two bases. Each of the two bases has a first through hole and a second through hole, and an extending length direction of the first through hole and an extending direction of the second through hole are staggered relative to the surrounding side surface.

### CROSS-REFERENCE TO RELATED PATENT APPLICATION

This application claims the benefit of priority to Taiwan Patent Application No. 111200833, filed on Jan. 21, 2022. The entire content of the above identified application is incorporated herein by reference.

### FIELD OF THE DISCLOSURE

The present disclosure relates to an electric fan, and more particularly to a portable electric fan.

### BACKGROUND OF THE DISCLOSURE

In the related art, when a portable electric fan (or an outdoor electric fan) is in use, the portable electric fan is usually based on the bracket to align the fan in a specific direction, angle, or set the fan in a specific position so as to blow and deliver air to a target.

However, the brackets of the portable electric fan mostly are directly locked to a main body thereof, so that when the portable electric fan is placed in a place where it is difficult to place it stably (e.g., tree or stairs), the portable electric fan cannot be steadily placed and correspondingly deliver air to the target. In addition, in the related art, the portable electric fan has a large volume and is inconvenient to carry or store.

### SUMMARY OF THE DISCLOSURE

In response to the above-referenced technical inadequacies, the present disclosure provides a portable electric fan.

In one aspect, the present disclosure provides a portable electric fan, and the portable electric fan includes a shell, a fan module, and a plurality of combined seat groups. The shell has a first surface, a second surface opposite to the first surface, and a surrounding side surface that is connected to the first surface and the second surface. The shell has a hollow portion that passes through the first surface and the second surface. The fan module includes a motor and a fan blade that is mounted on the motor, and the fan module is mounted in the hollow portion. The combined seat groups are mounted on the surrounding side surface, and each of the combined seat groups includes two bases that are spaced apart from each other and substantially in a mirror symmetry and a bracket detachably mounted to the two bases. Each of the two bases has a first through hole and a second through hole spaced apart from each other, and an extending length direction of the first through hole and an extending direction of the second through hole are staggered relative to the surrounding side surface. Two of the length directions of two of the first through holes of the two bases of each of the combined seat groups are parallel to each other, and the bracket passes through and is disposed to two of the first through holes of the two bases.

Therefore, in the portable electric fan provided by the present disclosure, by virtue of “each of the two bases having a first through hole and a second through hole spaced apart from each other, and an extending length direction of the first through hole and an extending direction of the second through hole are staggered relative to the surrounding side surface” and “two of the length directions of two of the first through holes of the two bases of each of the combined seat groups are parallel to each other, and the bracket passes through and is disposed to two of the first through holes of the two bases”, the portable electric fan can be suitable for various environments where it is difficult to place the portable electric fan, and can correspondingly provide various usage modes for users to choose.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a portable electric fan according to an embodiment of the present disclosure;

FIG. 2 is a rear view of the portable electric fan according to the embodiment of the present disclosure;

FIG. 3 is a side view of the portable electric fan according to the embodiment of the present disclosure;

FIG. 4 is a bottom view of the portable electric fan according to the embodiment of the present disclosure;

FIG. 5 is an exploded view of the portable electric fan according to the embodiment of the present disclosure;

FIG. 6 is a partial schematic perspective view of the portable electric fan according to the embodiment of the present disclosure;

FIG. 7 is a schematic perspective view of a combined seat group according to the embodiment of the present disclosure;

FIG. 8 is a schematic view of a power supply device and three insertion portions according to the embodiment of the present disclosure;

FIG. 9 is a bottom view of the power supply device and the three insertion portions according to the embodiment of the present disclosure;

FIG. 10 is a first use state view of the portable electric fan according to the embodiment of the present disclosure;

FIG. 11 is the first use state view from another perspective of the portable electric fan according to the embodiment of the present disclosure;

FIG. 12 is a second use state view of the portable electric fan according to the embodiment of the present disclosure;

FIG. 13 is the second use state view from another perspective of the portable electric fan according to the embodiment of the present disclosure; and

FIG. 14 is a third use state view of the portable electric fan according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

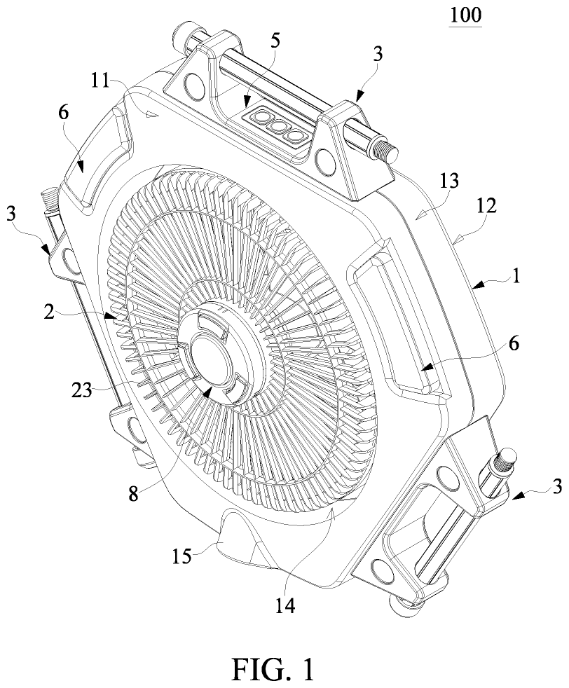

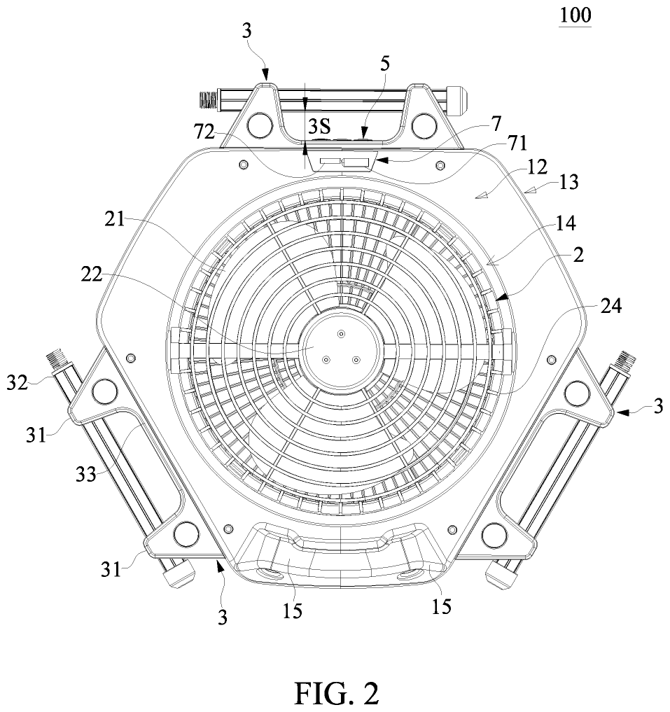

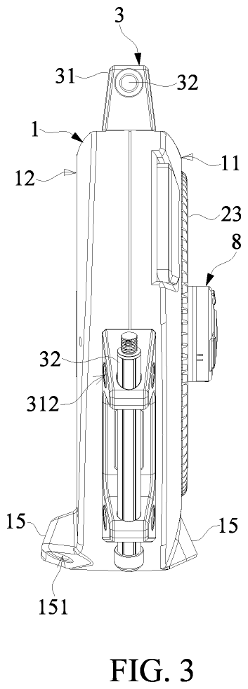

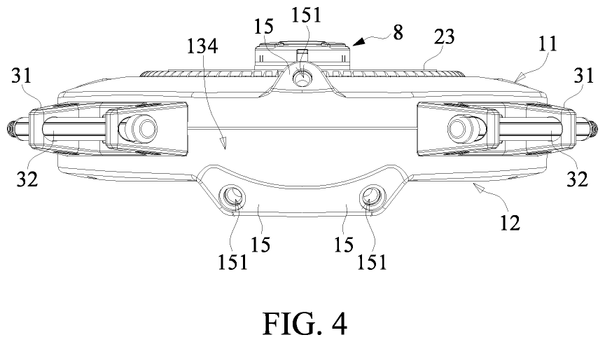

Referring to FIG. 1 to FIG. 14, an embodiment of the present disclosure provides a portable electric fan 100, and as shown in FIG. 1, and FIG. 2 to FIG. 6, the portable electric fan 100 includes a shell 1, a fan module 2, a plurality of combined seat groups 3, a power supply device 4, a control device 5, two illuminating lamps 6, a charging device 7, and a remote control device 8, but the present disclosure is not limited thereto. For example, in other embodiments not shown in the present disclosure, the portable electric fan 100 can be provided without the two illuminating lamps 6 and the remote control device 8.

As shown in FIG. 1 to FIG. 5, the shell 1 has a first surface 11, a second surface 12 opposite to the first surface 11, and a surrounding side surface 13 that is connected to the first surface 11 and the second surface 12. In addition, the first surface 11 and the second surface 12 have a distance there-between that is within a range from 80 mm to 120 mm, but the present disclosure is not limited thereto. For example, in other embodiments not shown in the present disclosure, the above-mentioned distance can be adjusted according to practical requirements.

Specifically speaking, in the present embodiment, the shell 1 preferably has a hexahedral shape, and the surrounding side surface 13 has a first side surface 131, two second side surfaces 132, two third side surfaces 133 and a fourth side surface 134.

In addition, the first side surface 131 corresponds in position to the fourth side surface 134, each of the two second side surfaces 132 is connected to the first side surface 131 and one of the two third side surfaces 133, and each of the two second side surfaces 132 corresponds in position to another one of the third side surfaces 133.

It should be noted that a length of the first side surface 131 is greater than a length of the fourth side surface 134, and a length of each of the two second side surfaces 132 is less than a length of each of the two third side surfaces 133.

That is, in the present embodiment, the shell 1 has an irregular hexahedral shape, but the present disclosure is not limited thereto. For example, in other embodiments not shown in the present disclosure, the shell 1 can have the regular hexahedral shape, or in other geometric solid structures.

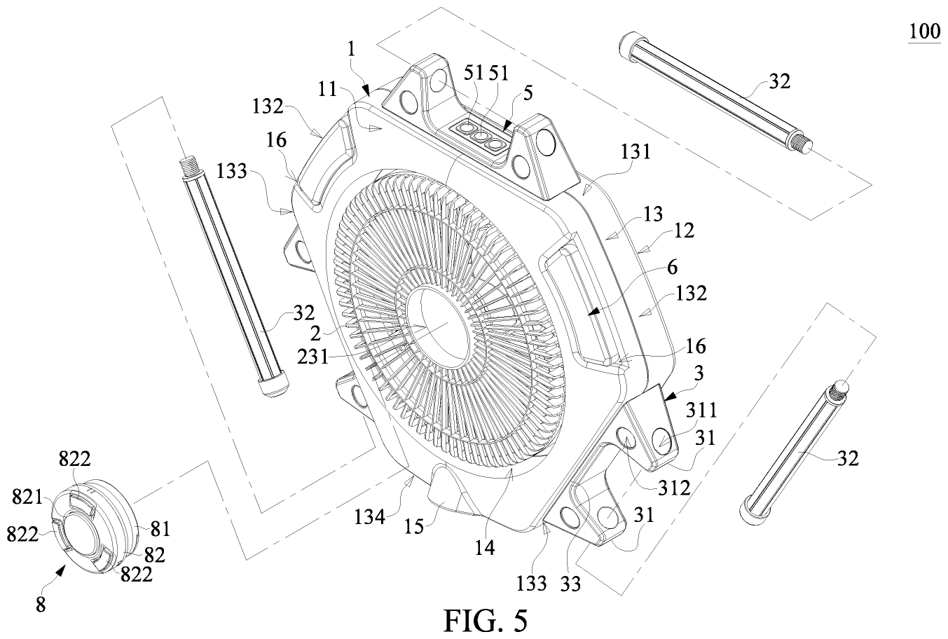

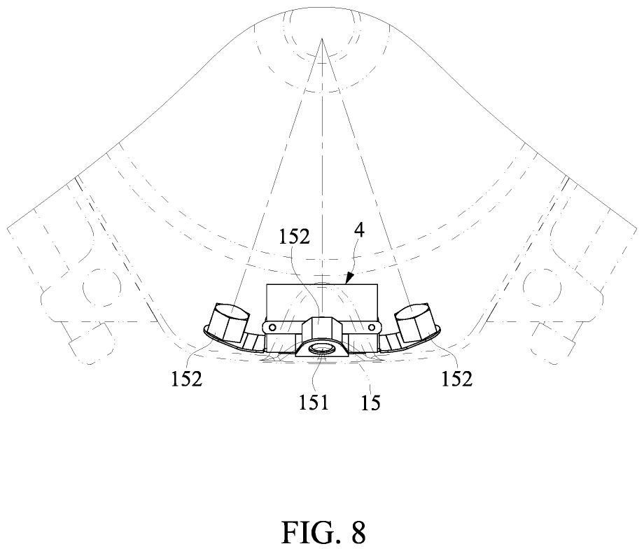

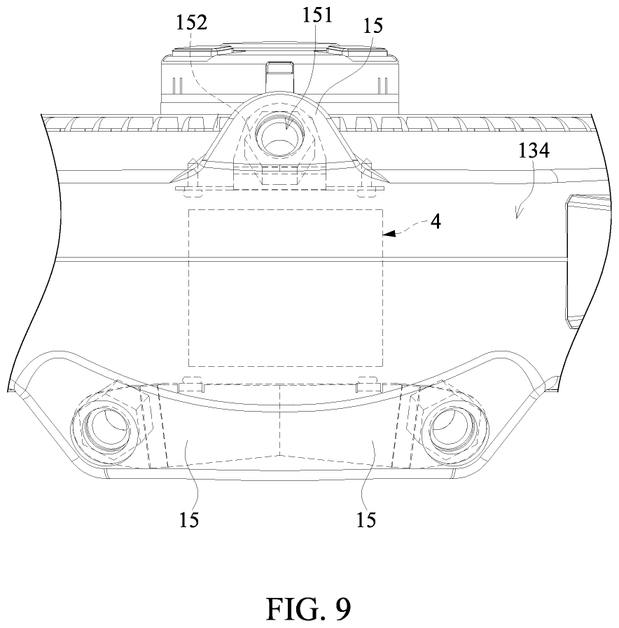

It should be noted that, as shown in FIG. 5, FIG. 8, and FIG. 9, the shell 1 further has a hollow portion 14, three insertion portions 15 and two accommodating grooves 16, but the present disclosure is not limited thereto. For example, in other embodiments not shown in the present disclosure, the shell 1 can be provided without the three insertion portions 15 and the two accommodating grooves 16, and the number of the insertion portion 15 and the accommodating groove 16 can be adjusted according to practical requirements.

Specifically speaking, in the present embodiment, the hollow portion 14 is preferably annular, the hollow portion 14 passes through the first surface 11 and the second surface 12, and the fan module 2 is mounted in the hollow portion 14. In addition, a diameter of the hollow portion 14 is within a range from 284 mm to 380 mm, and the fan module 2 and an inner surface of the hollow portion 14 are spaced apart from each other.

In addition, as shown in FIG. 5, FIG. 8, and FIG. 9, one of the three insertion portions 15 is convexly formed on the first surface 11 and close to the fourth side surface 134, another two of the three insertion portions 15 are convexly formed on the second surface 12 and close to the fourth side surface 134, and the three insertion portions 15 and the fourth side surface 134 of the surrounding side surface 13 jointly define a supporting bottom surface (not labeled).

Specifically speaking, the supporting bottom surface has three endpoints and three edges. That is, in the present embodiment, the supporting bottom surface has a triangular shape, but the present disclosure is not limited thereto. In addition, the three endpoints respectively correspond in position to the three edges of the supporting bottom surface, and any one of the three endpoints and one of the three edges that correspond thereto have a vertical distance that is within a range from 125 mm to 150 mm, but the present disclosure is not limited thereto.

The three insertion portions 15 can be formed on the first surface 11 or the second surface 12 according to practical requirements, and the above-mentioned vertical distance can be adjusted according to practical requirements.

Specifically speaking, as shown in FIG. 8, each of the three insertion portions 15 includes an insertion hole 151 and a fixing member 152 that is mounted in the shell 1, directions of three central axes (not labeled) of three of the insertion holes 151 of the three insertion portions 15 are staggered with each other, and each of the three insertion portions 15 and the hollow portion 14 are spaced apart from each other.

In addition, the direction of three central axes of any one of three of the insertion holes 151 and the directions of three central axes of the other insertion holes 151 have an included angle (not labeled) that is between 30 degrees and 90 degrees, and the included angle is preferably within a range from 45 degrees to 60 degrees, but the present disclosure is not limited thereto.

More specifically, the insertion hole 151 has a screw structure (not shown) formed on an inner surface thereof, the fixing member 152 corresponds in position to the insertion hole 151, and the fixing member 152 in the present embodiment is a cap nut, but the present disclosure is not limited thereto. For example, in other embodiments not shown in the present disclosure, the insertion hole 151 can be provided without the screw structure.

In addition, as shown in FIG. 5, the first surface 11 of the shell 1 is recessed from an edge thereof to form the two accommodating grooves 16 that are spaced from each other, the fan module 2 is arranged between the two accommodating grooves 16, and each of the two accommodating grooves 16 is arranged between two of the combined seat groups 3, but the present disclosure is not limited thereto. For example, in other embodiments not shown in the present disclosure, each of the two accommodating grooves 16 can be provided without being recessed from the edge of the first surface 11 and can be directly formed on the first surface 11, and each of the two accommodating grooves 16 can be arranged between the edge of the first surface 11 and the hollow portion 14.

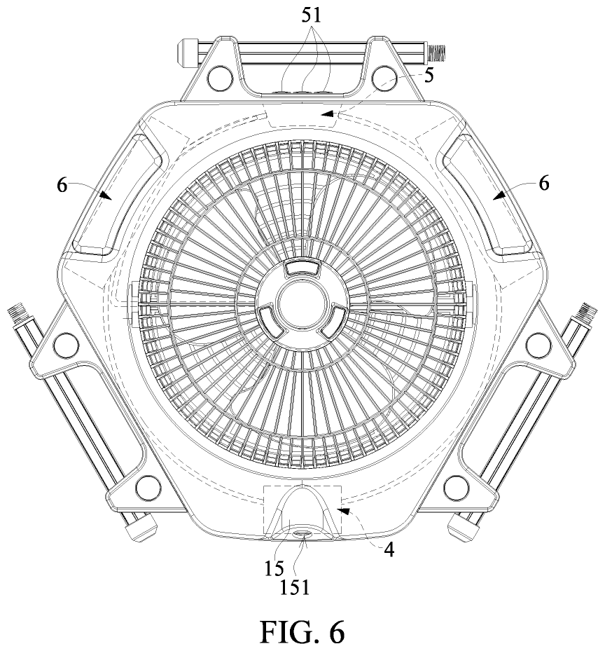

It should be noted that, as shown in FIG. 5 and FIG. 6, in the present embodiment, the two illuminating lamps 6 are respectively mounted in the two accommodating grooves 16, each of the two illuminating lamps 6 is electrically connected to the power supply device 4 and the control device 5, and each of the two illuminating lamps 6 is a light-emitting diode (LED).

As shown in FIG. 1 and FIG. 2, the fan module 2 includes a fan blade 21, a motor 22 that is mounted to the fan blade 21, a front grille 23 and a rear grille 24 mounted to each other, the fan blade 21 and the motor 22 are arranged between the front grille 23 and the rear grille 24, and the front grille 23 has a groove 231 formed on a center thereof.

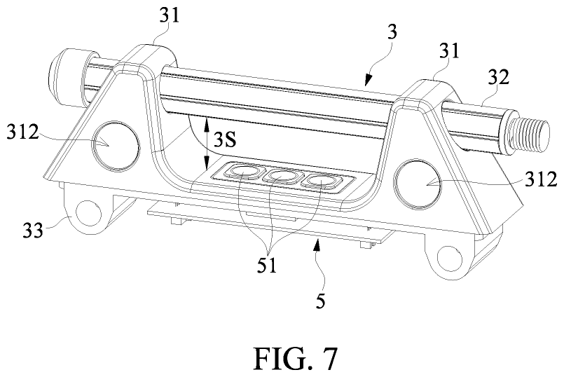

As shown in FIG. 5 and FIG. 7, the combined seat groups 3 are mounted on the surrounding side surface 13, each of the combined seat groups 3 includes two bases 31, a bracket 32 detachably mounted to the two bases 31, and a connecting seat 33, the connecting seat 33 and the two bases 31 are integrally formed. In addition, each of the brackets 32 is telescopic so that each of the brackets 32 can extend a length thereof, but the present disclosure is not limited thereto. For example, in other embodiments not shown in the present disclosure, each of the combined seat groups 3 can be provided without the connecting seat 33, and a mounting position of the combined seat groups 3 can also be adjusted according to practical requirements.

Specifically speaking, in the present embodiment, the number of the combined seat groups 3 is preferably three, the three combined seat groups 3 are respectively mounted on the first side surface 131 and the two third side surfaces 133, and the connecting seat 33 of each of the three combined seat groups 3 is partially mounted in the shell 1. In addition, a grip distance 3S is defined between the connecting seat 33 and the bracket 32, and the grip distance 3S is within a range from 3 cm to 5 cm, but the present disclosure is not limited thereto.

It should be noted that, as shown in FIG. 7, the two bases 31 are spaced apart from each other and substantially in a mirror symmetry, each of the two bases 31 has a first through hole 311 and a second through hole 312 spaced apart from each other, and an extending length direction of the first through hole 311 and an extending direction of the second through hole 312 are staggered relative to the surrounding side surface 13.

In other words, a perpendicular projection of a length direction of the first through hole 311 and a perpendicular projection of a length direction of the second through hole 312 both projected onto the surrounding side surface are staggeredly disposed on the surrounding side surface 13.

In addition, two of the length directions of two of the first through holes 311 of the two bases 31 of each of the combined seat groups 3 are parallel to each other, and the bracket 32 passes through and is disposed to two of the first through holes 311 of the two bases 31, but the present disclosure is not limited thereto.

It should be noted that for ease of illustration, multiple assembling ways of the combined seat groups 3 and the shell 1 will be described below.

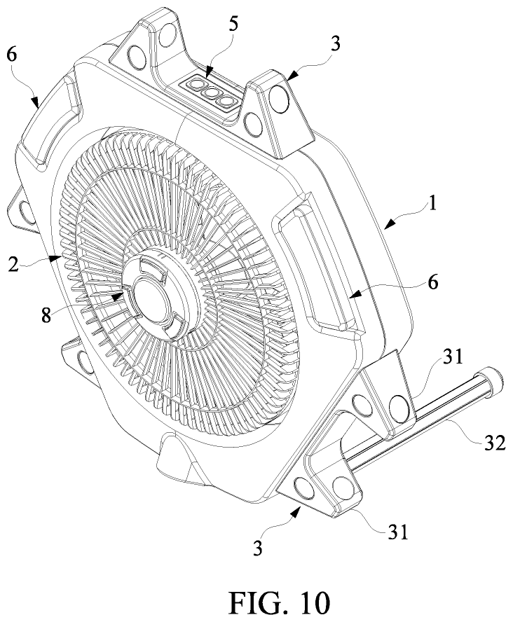

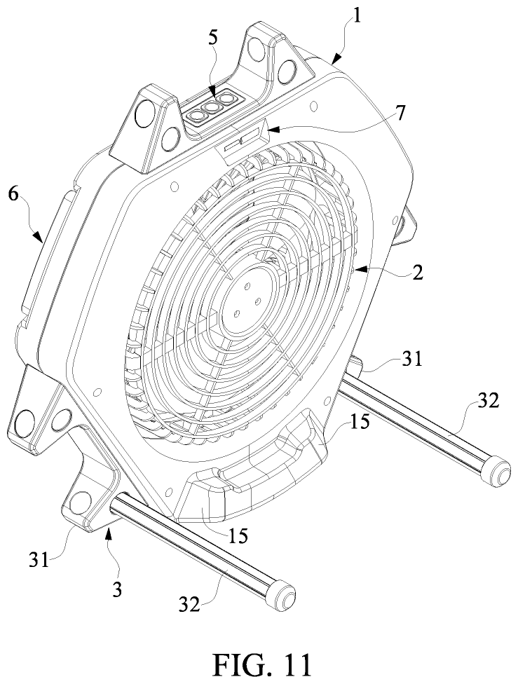

As shown in FIG. 5, FIG. 8, FIG. 10, and FIG. 11, two of the three brackets 32 can respectively pass through and be disposed to the two bases 31 of two of the three combined seat groups 3 that are respectively disposed on the two third side surfaces 133, and two of the three brackets 32 that are mentioned above respectively pass through the two second through holes 312 that are adjacent to the fourth side surface 134, so that the shell 1 can stand on the ground by the fourth side surface 134 (the supporting bottom surface) and two of the three brackets 32.

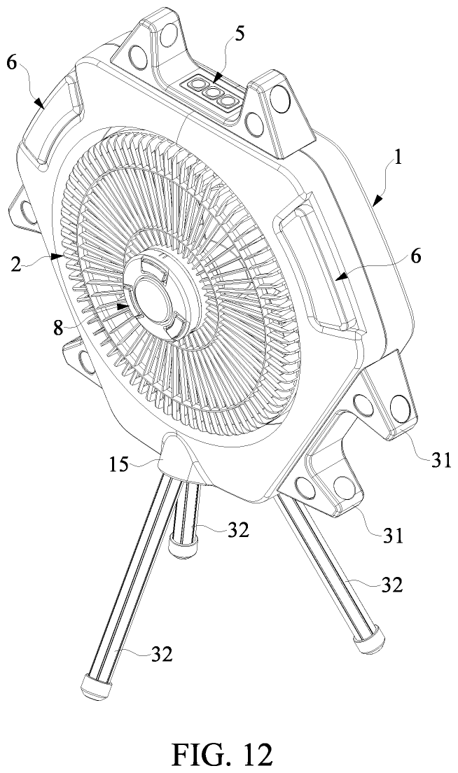

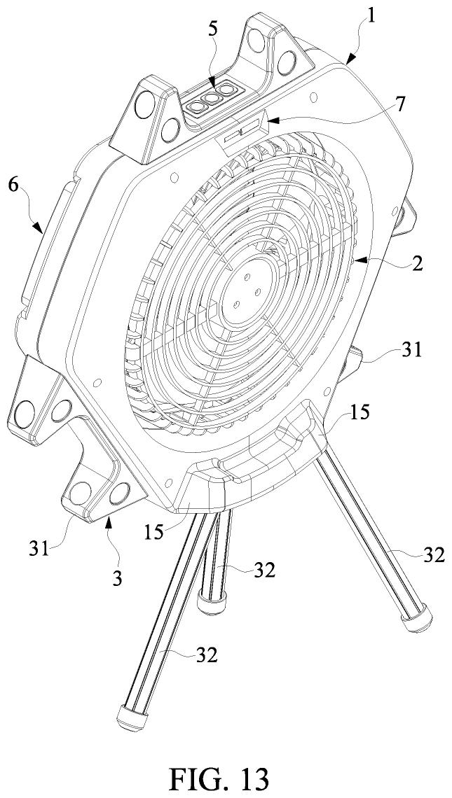

As shown in FIG. 5, FIG. 8, FIG. 12, and FIG. 13, the three brackets 32 can respectively be inserted into the three the insertion portions 15 and respectively be fixed (blocked) by the three fixing members 152, so that the shell 1 and the fan module 2 are away from the ground and stand upright.

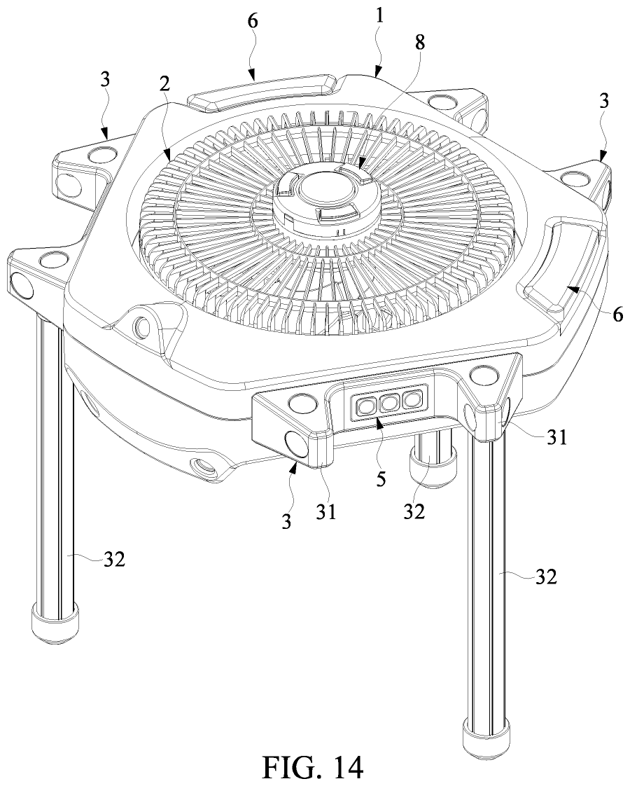

As shown in FIG. 5, FIG. 8, and FIG. 14, the three brackets 32 can also respectively pass through three of the bases 31 of three of the combined seat groups 3 and respectively pass through three of the second through holes 312 of three of the bases 31 that are mentioned above, so that the shell 1 can blow and deliver air to a direction that is opposite to the ground.

As shown in FIG. 6, FIG. 8, and FIG. 9, the control device 5 is electrically connected to the power supply device 4, the power supply device 4 is disposed in the shell 1 and spaced apart from the three insertion portions 15, and the control device 5 is disposed in the shell 1 and corresponds in position to the power supply device 4. In addition, the fan module 2 is arranged between the power supply device 4 and the control device 5, and the control device 5 includes a plurality of control buttons 51 that are partially exposed outside the surrounding side surface 13.

Specifically speaking, in the present embodiment, the power supply device 4 is preferably a battery pack containing six lithium batteries (not shown), each of the six lithium batteries is a 18650 lithium battery, and the number of the control buttons 51 is preferably three. In addition, the control buttons 51 can be used to respectively control the fan module 2 and the two illuminating lamps 6, but the present disclosure is not limited thereto.

As shown in FIG. 1, FIG. 2, and FIG. 6, the charging device 7 is disposed on the second surface 12 of the shell 1 and adjacent to the control device 5. In addition, the charging device 7 includes a charging jack 71 and a discharge jack 72, the charging jack 71 and the discharge jack 72 are electrically connected to the power supply device 4, and in the present embodiment, the charging jack 71 and the discharge jack 72 are respectively a Type C jack and a Type A jack, but the present disclosure is not limited thereto.

For example, in other embodiments not shown in the present disclosure, the charging device 7 can also include various other types of jacks, such as Mini B jacks and Micro B jacks. In addition, it should be noted that in the present embodiment, the charging jack 71, which is a Type C jack, can be used not only for charging, but also for discharging. To avoid misunderstanding, it is explained here.

As shown in FIG. 5, the remote control device 8 is detachably disposed in the groove 231 and configured to control the fan module 2 by a wireless remote manner. Specifically speaking, the remote control device 8 includes a magnetic portion 81 and a function portion 82 that is mounted on the magnetic portion 81, the magnetic portion 81 is detachably disposed in the groove 231, and the function portion 82 is exposed outside the groove 231.

In addition, in other embodiments not shown in the present disclosure, the magnetic portion 81 can further include a handle (not labeled) that is configured to be mounted on an edge of the magnetic portion 81, but the present disclosure is not limited thereto.

It should be noted that the function portion 82 includes a secondary illumination lamp 821 and a plurality of remote buttons 822 that are arranged around and spaced apart from the secondary illumination lamp 821, and the remote buttons 822 are configured to control the fan module 2 and the two illuminating lamps 6.

In addition, in the present embodiment, the remote buttons 822 control the fan module 2 and the two illuminating lamps 6 by an infrared remote control manner, but the present disclosure is not limited thereto. For example, in other embodiments not shown in the present disclosure, the remote buttons 822 can control the fan module 2 and the two illuminating lamps 6 by Bluetooth remote control.

Furthermore, by virtue of “the handle of the magnetic portion 81 and the secondary illumination lamp 821 cooperating with each other to separate the remote control device 8 from the groove 231”, the remote control device 8 can serve as a lantern, a night light or a flashlight.

### Beneficial Effects of the Embodiments

In conclusion, in the portable electric fan 100 provided by the present disclosure, by virtue of “each of the two bases 31 having a first through hole 311 and a second through hole 312 spaced apart from each other, and an extending length direction of the first through hole 311 and an extending direction of the second through hole 312 being staggered relative to the surrounding side surface 13” and “two of the length directions of two of the first through holes 311 of the two bases 31 of each of the combined seat groups 3 being parallel to each other, and the bracket 32 passing through and being disposed to two of the first through holes 311 of the two bases 31”, the portable electric fan 100 can be suitable for various environments where it is difficult to place the portable electric fan, and can correspondingly provide various usage modes for users to choose.

Furthermore, by virtue of “the shell 1 further having three insertion portions 15, one of the insertion portions 15 being convexly formed on the first surface 11, another two of the insertion portions 15 being convexly formed on the second surface 12, and the three insertion portions 15 and a part of the surrounding side surface 13 jointly defining a supporting bottom surface”, the portable electric fan 100 can be used as a vertical electric fan, and when the portable electric fan 100 is stored, the space that portable electric fan 100 occupies will not increase.

Furthermore, by virtue of “directions of three central axes of three of the insertion holes 151 of the three insertion portions 15 being staggered with each other, and the direction of three central axes of any one of three of the insertion holes 151 and the directions of three central axes of the other insertion holes 151 having an included angle that is between 30 degrees and 90 degrees” when the portable electric fan 100 is used as a vertical electric fan, the portable electric fan 100 has a plurality of steady points of support to prevent the portable electric fan 100 from being easily pushed down by external forces.

Furthermore, by virtue of “the two illuminating lamps 6 of the portable electric fan 100 being respectively mounted in the two accommodating grooves 16, and each of the two illuminating lamps 6 being electrically connected to the power supply device 4 and the control device 5”, the portable electric fan 100 has a lighting function, and the portable electric fan 100 can be used as a lantern.

Furthermore, by virtue of “the magnetic portion 81 of the remote control device 8 being detachably disposed in the groove 231, and the function portion 82 is exposed outside the groove 231” and “the function portion 82 including a secondary illumination lamp 821 and a plurality of remote buttons 822 that are arranged around and spaced apart from the secondary illumination lamp 821, and the remote buttons 822 being configured to control the fan module 2”, the portable electric fan 100 can be operated remotely, and the lighting function of the portable electric fan 100 is enhanced.

Furthermore, by virtue of “the connecting seat 33 of each of the combined seat groups 3 being partially mounted in the shell 1, and the connecting seat 33 and the two bases 31 being integrally formed, and in which the grip distance 3S is defined between the connecting seat 33 and the bracket 32, and the grip distance 3S being within a range from 3 cm to 5 cm”, the portable electric fan 100 can be easily picked up by the user.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A portable electric fan, comprising:
a shell having a first surface, a second surface opposite to the first surface, and a surrounding side surface that is connected to the first surface and the second surface, wherein the shell has a hollow portion that passes through the first surface and the second surface;
a fan module including a motor and a fan blade that is mounted on the motor, wherein the fan module is mounted in the hollow portion; and
a plurality of combined seat groups mounted on the surrounding side surface, wherein each of the combined seat groups includes two bases that are spaced apart from each other and substantially in a mirror symmetry, and a bracket detachably mounted to the two bases, and wherein each of the two bases has a first through hole and a second through hole spaced apart from each other, and an extending length direction of the first through hole and an extending direction of the second through hole are staggered relative to the surrounding side surface;
wherein two of the length directions of two of the first through holes of the two bases of each of the combined seat groups are parallel to each other, and the bracket passes through and is disposed to two of the first through holes of the two bases.

2. The portable electric fan according to claim 1, wherein the shell further has three insertion portions, one of the three insertion portions is convexly formed on the first surface, another two of the three insertion portions are convexly formed on the second surface, and the three insertion portions and a part of the surrounding side surface jointly define a supporting bottom surface.

3. The portable electric fan according to claim 2, wherein each of the three insertion portions includes an insertion hole and a fixing member that is mounted in the shell, directions of three central axes of three of the insertion holes of the three insertion portions are staggered with each other, and each of the three insertion portions and the hollow portion are spaced apart from each other, and wherein the direction of three central axes of any one of three of the insertion holes and the directions of three central axes of the other insertion holes have an included angle that is between 30 degrees and 90 degrees.

4. The portable electric fan according to claim 2, further comprising a power supply device and a control device that is electrically connected to the power supply device, wherein the power supply device is disposed in the shell and spaced apart from the three insertion portions, and the control device is disposed in the shell and corresponds in position to the power supply device, and wherein the fan module is arranged between the power supply device and the control device, and the control device includes a plurality of control buttons that are partially exposed outside the surrounding side surface.

5. The portable electric fan according to claim 4, wherein the first surface of the shell is recessed from an edge thereof to form two accommodating grooves that are spaced from each other, the fan module is arranged between the two accommodating grooves, and each of the two accommodating grooves is arranged between two of the combined seat groups, and wherein the portable electric fan further includes two illuminating lamps that are respectively mounted in the two accommodating grooves, and each of the two illuminating lamps is electrically connected to the power supply device and the control device.

6. The portable electric fan according to claim 4, further comprising a charging device that is disposed on the second surface of the shell and adjacent to the control device, wherein the charging device includes a charging jack and a discharge jack, and the charging jack and the discharge jack are electrically connected to the power supply device.

7. The portable electric fan according to claim 1, wherein the fan module further includes a front grille and a rear grille mounted to each other, the fan blade and the motor are arranged between the front grille and the rear grille, and the front grille has a groove formed on a center thereof, and wherein the portable electric fan further includes a remote control device that is detachably disposed in the groove and configured to control the fan module by a wireless remote manner.

8. The portable electric fan according to claim 7, wherein the remote control device further includes a magnetic portion and a function portion that is mounted on the magnetic portion, the magnetic portion is detachably disposed in the groove, and the function portion is exposed outside the groove, and wherein the function portion includes a secondary illumination lamp and a plurality of remote buttons that are arranged around and spaced apart from the secondary illumination lamp, and the remote buttons are configured to control the fan module.

9. The portable electric fan according to claim 1, wherein the shell has a hexahedral shape, the surrounding side surface has a first side surface, two second side surfaces, two third side surfaces, and a fourth side surface, the first side surface corresponds in position to the fourth side surface, and each of the two second side surfaces is connected to the first side surface and one of the two third side surfaces, wherein each of the two second side surfaces corresponds in position to another one of the third side surfaces, and wherein a length of the first side surface is greater than a length of the fourth side surface, and a length of each of the two second side surfaces is less than a length of each of the two third side surfaces.

10. The portable electric fan according to claim 1, wherein each of the combined seat groups further includes a connecting seat that is partially mounted in the shell, and the connecting seat and the two bases are integrally formed, and wherein a grip distance is defined between the connecting seat and the bracket, and the grip distance is within a range from 3 cm to 5 cm.
